(19) United States
(12) Patent Application Publication
(10) Pub. No.: US 2005/0023319 A1
(43) Pub. Date: Feb. 3, 2005

(54) Safety device for pneumatic staplers

(76) Inventor: Chen-Fa Huang, Ta Li City (TW)

Correspondence Address: Mr. Phillip LIU, 6980 Whiteoak Dr, Richmond, BC, V7E 4Z9, CA

(21) Appl. No.: 10/632,640

(22) Filed: Aug. 1, 2003

(51) Int. Cl. B25C 1/04

(52) U.S. Cl. 227/8; 227/130

(57) ABSTRACT

A safety device for a pneumatic stapler includes a pivotable member having a first end connected to a top of a stop member and a second end which can be pushed by a connection link connected to a rod which is pushed against the object to be stapled. The stop member can therefore be lifted and is pushed by the trigger to activate the activation member to open the valve to allow pressurized air to eject a staple. The activation member cannot be pushed if the stop member is not lifted to its operation position even if the trigger is pulled.

### FIELD OF THE INVENTION

The present invention relates to a safety device for pneumatic stapler and includes a link assembly which lifts a stop member to allow the activation member to be pushed by the trigger when the safety device is activated.

### BACKGROUND OF THE INVENTION

A conventional pneumatic stapler generally includes a barrel with a nose connected to a front end of the barrel and a magazine is removably connected to the barrel so as to provide staples to the stapler. A trigger is pivotably connected to the handle and is able to activate an activation member to open a valve to allow pressurized air enter a certain air path to inject a staple from the nose. In order to prevent mis-function or mis-operation of the stapler, a safety device is provided to the stapler and includes a rod connected to the trigger so that when using the stapler, the rod has to be pushed against the surface of the object to be stapled and the trigger can be activated to its operational position. The activation member is then activated by pulling the trigger. Nevertheless, the safety devices of prior arts have a common problem which is that too many parts are involved and this makes the stapler to be heavy and bulky.

The present invention intends to provide a safety device for stapler wherein the number of the parts of the safety device is much less than the conventional ones.

### SUMMARY OF THE INVENTION

In accordance with one aspect of the present invention, there is provided a safety device for staplers and the safety device comprises a rod connected to a connection link. A link assembly includes a pivotable member which has a first end connected to a top of a stop member and a second end which is located beside an end of the connection link. A spring is connected to an underside of the stop member which is connected to a trigger of the stapler. The second end of the pivotable member can be pushed by the end of the connection link so as to lift the stop member to an operation position where an activation member is can be pressed by the stop member when pulling the trigger.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the safety device of the present invention;

FIG. 1 is a perspective view to show the safety device of the present invention is installed to a stapler;

FIG. 3 shows the activation member is not pressed if the rod of the safety device is not pushed;

FIG. 4 shows the stop member is lifted when the rod of the safety device is pushed against an object to be stapled;

FIG. 5 shows another embodiment of the connection of the stop member and the pivotable member;

FIG. 6 shows the activation member is not pressed in the embodiment of FIG. 5., if the rod of the safety device is not pushed;

FIG. 7 shows the activation member is pressed by the stop member in the embodiment of FIG. 5 if the rod of the safety device is pushed;

FIG. 8 shows yet another embodiment of the safety device of the present invention, and FIG. 9 shows the stop member of the embodiment as shown in FIG. 8 is lifted.

### DETAILED DESCRIPTION OF THE PREFERRED EMBODIMENT

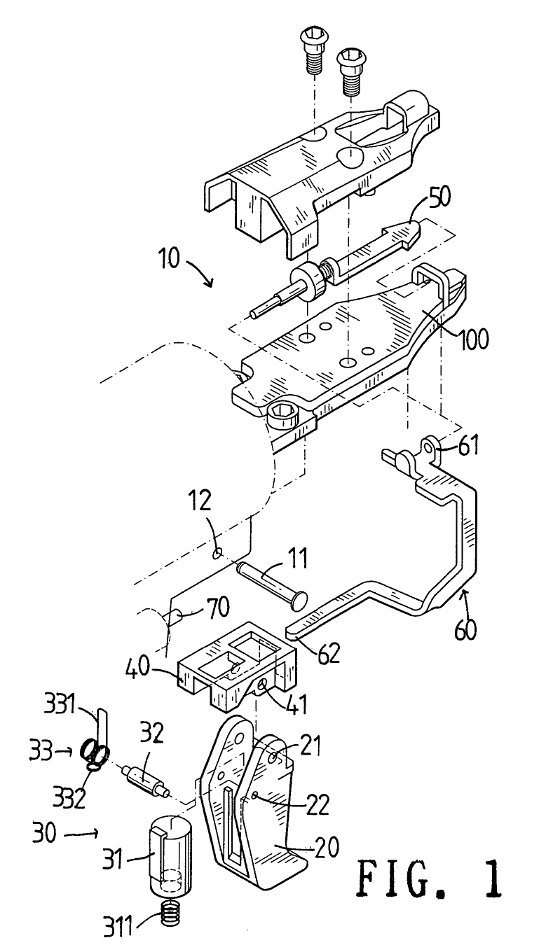

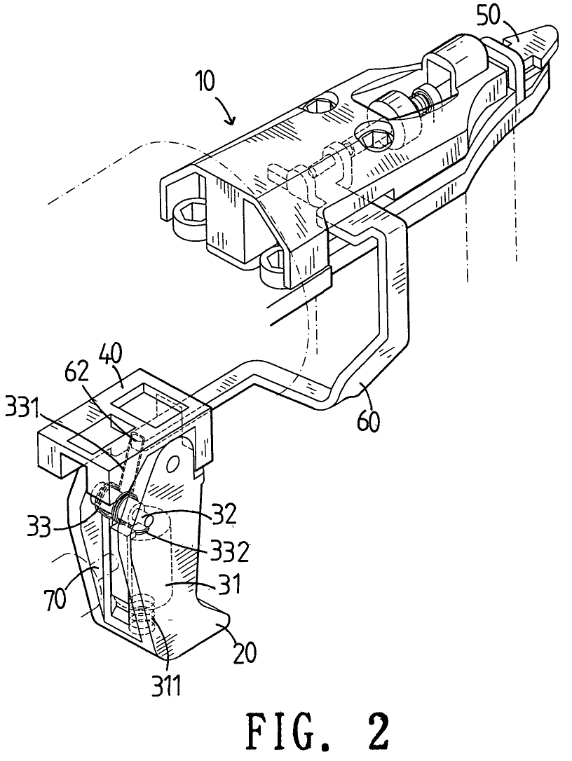

Referring to FIGS. 1 to 3, the safety device for staplers of the present invention comprises a rod 50 which has a first end connected to a first end 61 of a connection link 60 and a second end of the rod 50 is extended over a nose 100 of the stapler. A trigger 20 includes two side walls which are pivotably connected to a frame 40 connected to the barrel 10 of the stapler by extending a pin 11 through holes 21 in the two side walls of the trigger 20, the holes 41 in the frame 40 and a passage 12 in the barrel 10.

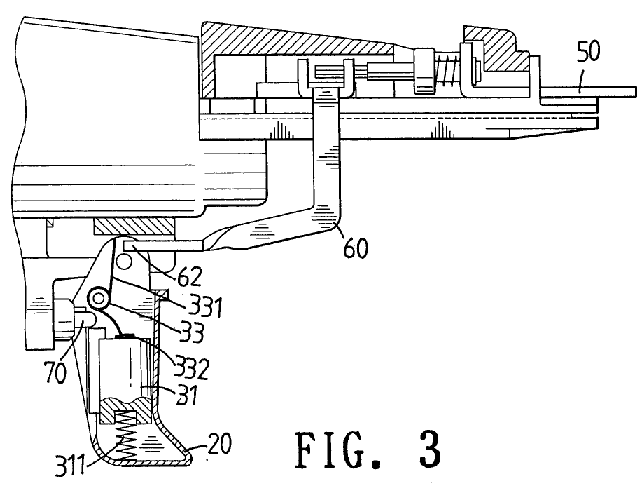

A link assembly 30 includes a pivotable member 33 which is a torsion spring and is mounted to a transverse link 32 which is connected between two holes 22 in the two side walls of the trigger 20. The pivotable member 33 has a first end 322 connected to a top of a stop member 31 and a second end 331 which is located beside a second end 62 of the connection link 60. The stop member 31 is a cylindrical member and a recess is defined in the underside of the stop member 31 so that an end of a spring 311 is engaged with the recess. The stop member 31 is located between the two side walls of the trigger 20 connected to the trigger of the stapler and is moved with the trigger 20. An activation member 70 extends from the barrel 10 and into the space between the two side walls of the trigger 20. As shown in FIG. 3, if the trigger 20 is pulled while the rod 50 is not pushed against an object to be stapled, the activation member 70 is not pressed by any part of the trigger 20 and the staple is not injected from the nose 100.

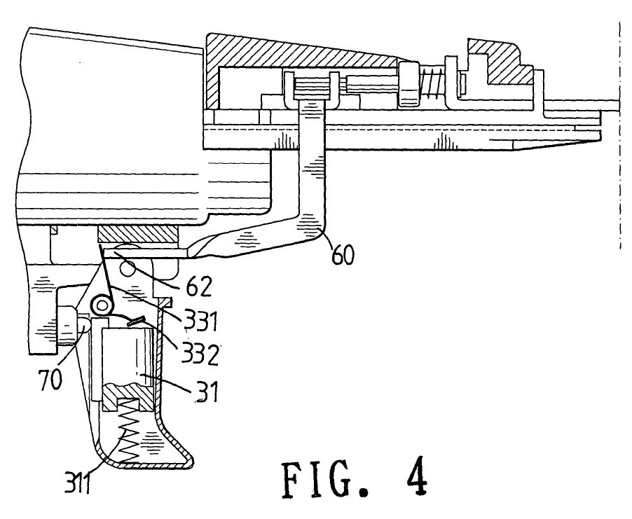

As shown in FIG. 4, if the rod 50 is pushed against the object to be stapled, the rod 50 is pushed backward and the second end 331 of the pivotable member 33 is pushed by the second end 62 of the connection link 60 so that the stop member 31 is bounced upward by the spring 311 to an operation position where the activation member 70 is pressed by the stop member 33 if the trigger 20 is pulled.

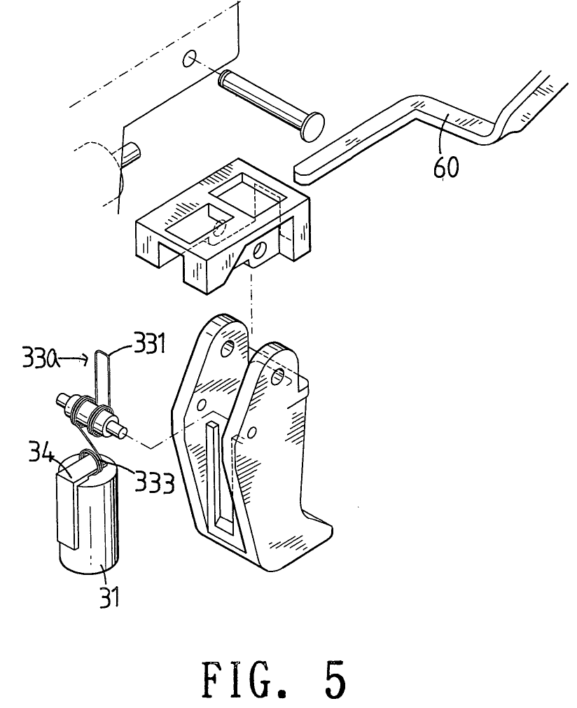

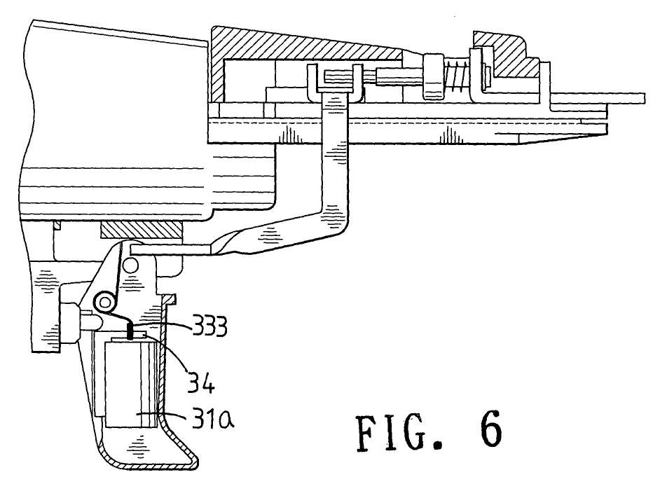

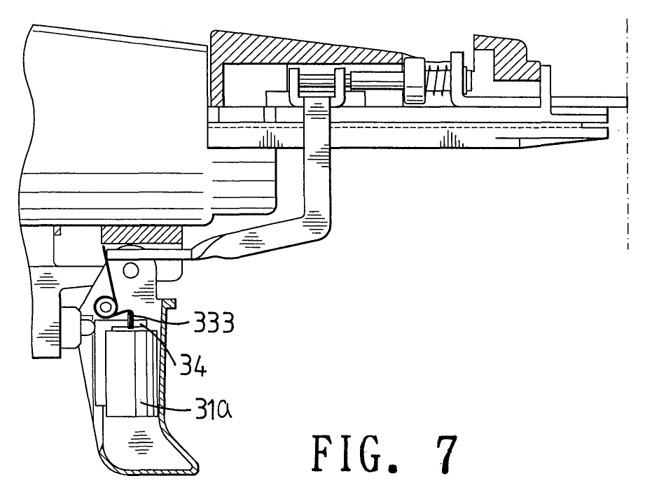

Referring FIGS. 5 to 7, a tongue 34 may be connected to the top of the stop member 31a and the first end 333 of the pivotable member 33a is in a shape of a ring which is mounted to the tongue 34. When the second end 331 of the pivotable member 33a is pushed by the connection link 60, the stop member 31a is lifted up.

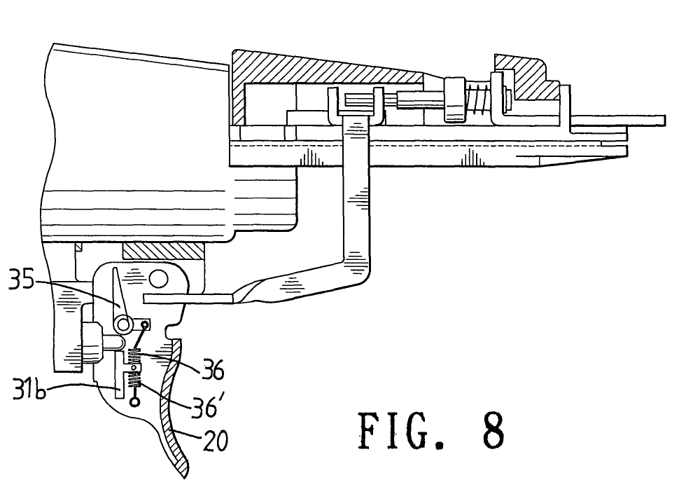

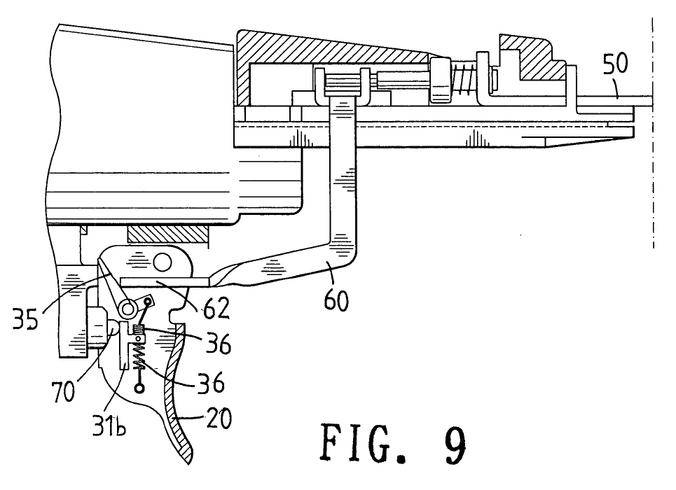

Referring to FIGS. 8 and 9, the stop member 31b may be a T-shaped member and includes an upright bar and a horizontal bar. Two pull springs 36 and 36′ are respectively connected to two sides of the horizontal bar. The pull spring 36 is connected between the second end of the pivotable member 35 and the horizontal bar. A same function is achieved as the embodiments in FIGS. 1 to 7 by this arrangement.

While we have shown and described the embodiment in accordance with the present invention, it should be clear to those skilled in the art that further embodiments may be made without departing from the scope of the present invention.

1. A safety device for staplers, comprising:
a rod having a first end connected to a first end of a connection link and a second end of the rod adapted to be extended over a nose of the stapler, and
a link assembly including a pivotable member which has a first end and a second end;
a T-shaped stop member having an upright bar and a horizontal bar, a pulling spring having an end connected to the horizontal bar and the other end of the pulling spring adapted to be connected to a trigger of the stapler, another pulling spring connected between the horizontal bar and the first end of the pivotable member, the second end of the pivotable member located beside a second end of the connection link and being pushed by the second end of the connection link so that the upright bar of the stop member is moved to an operation position where an activation member is pressed by the upright bar of the stop member.

2. The safety device as claimed in claim 1, wherein the stop member is a cylindrical member and a recess is defined in the underside of the stop member, an end of the spring is engaged with the recess.

3. The safety member as claimed in claim 1, wherein a tongue is connected to the top of the stop member and the first end of the pivotable member is connected to the tongue.

4. (Cancelled)
